(19) United States
(12) Patent Application Publication
(10) Pub. No.: US 2023/0394388 A1
(43) Pub. Date: Dec. 7, 2023

(54) SYSTEM AND METHOD FOR INCREASING PRODUCTIVITY OF AGENTS IN A CONTACT CENTER BY IMPROVING AN AUTOMATIC-SCHEDULING GENERATION IN A WORKFORCE MANAGEMENT (WFM) APPLICATION

(71) Applicant: NICE LTD., Ra'anana (IL)

(72) Inventors: Disha AGRAWAL, Pune (IN); Swapnil THAKARE, Pune (IN); Gaurav SURYAWANSHI, Pune (IN); Brijesh UPADHYAY, Pune (IN)

(21) Appl. No.: 17/832,746

(22) Filed: Jun. 6, 2022

(51) Int. Cl. G06Q 10/06; H04M 3/51

(52) U.S. Cl. CPC G06Q 10/06311; G06Q 10/06398; H04M 3/5175; H04M 2203/401; H04M 2203/402

(57) ABSTRACT

A computerized-method for increasing productivity of agents in a contact-center by improving an automatic-scheduling generation in a Workforce-Management (WFM) application, is provided herein. The computerized-method includes operating an Agent-Productivity-Score-Generator (APSG) module, for each agent. The APSG module includes: (i) receiving an activity-type and a period for agents shift-placement; (ii) retrieving historical-data of a preconfigured number of metrics for each scheduled-shift during a preconfigured period; (iii) calculating a weighted-sum of the retrieved historical-data of the preconfigured number of metrics and preconfigured attributed weight thereof to yield an Agent-Productivity-Score (APS) for each shift; and (iv) selecting a shift having a highest APS and adding the selected shift of the agent to a list-of-maximum-shifts. When the list-of-maximum-shifts is having all agents in a data-store then the list-of-maximum-shifts may be sent to the WFM for an automatic shift-schedule generation for the activity-type and a preconfigured period, based on the list-of-maximum-shifts and other input parameters.

### TECHNICAL FIELD

The present disclosure relates to the field of data analysis and more specifically to increasing productivity of agents in a contact center by improving an automatic-scheduling generation in a Workforce Management (WFM) application.

### BACKGROUND

In contact centers, Workforce Management (WFM) applications are driven by staffing plans, daily or weekly rules and agent's static preferences. Also, in current systems, ad hoc schedule changes are performed by a user, such as a manager without having proper insights as to best suited agent for a specified shift in the day in a specified day of the week. In contact centers having thousands of agents, in case of unexpected spikes in demand for call center services, e.g., unexpected high call volume, when the manager would like to adapt to the situation by adding agents which are not scheduled to the shift, the manager may require a list of suggested additional agents to be selected for activities on existing scheduled-shifts.

However, agent's productivity may differ throughout the day i.e., shift hours and also over the weekdays and a list of suggested agents for existing scheduled-shifts, in current solutions, may include agents for shift hours in which the agents may not be at their most productivity. Accordingly, there is a need for a technical solution for including agent's productivity using Key Performance Indicators (KPI)s as one of the parameters provided to the WFM application for providing a list of best suitable agents for scheduled-shifts during a preconfigured period, such as a week, based on the agents productivity.

Furthermore, there is a need for a system and method for increasing productivity of agents in a contact center by improving an automatic-scheduling generation in a Workforce Management (WFM) application.

### SUMMARY

There is thus provided, in accordance with some embodiments of the present disclosure, a computerized-method for increasing productivity of agents in a contact center by improving an automatic-scheduling generation in a Workforce Management (WFM) application.

Furthermore, in accordance with some embodiments of the present disclosure, in a computerized system that includes one or more processors one or more applications, and a memory including a data store of agents' metrics and skills and a data store of applications. The one or more processors may be operating an Agent Productivity Score Generator (APSG) module, for each agent in the data store of agents' metrics and skills.

Furthermore, in accordance with some embodiments of the present disclosure, the APSG module includes: (i) receiving an activity type and a period for agents shift placement; (ii) retrieving historical-data of a preconfigured number of metrics from the data store of agents' metrics and the data store of applications for each scheduled-shift during a preconfigured period; (iii) calculating a weighted sum of the retrieved historical-data of the preconfigured number of metrics and preconfigured attributed weight thereof to yield an Agent Productivity Score (APS) for each shift in the preconfigured period; and (iv) selecting a shift having a highest yielded APS and adding the selected shift of the agent to a list-of-maximum-shifts.

Furthermore, in accordance with some embodiments of the present disclosure, when the list-of-maximum-shifts is having all agents in the data store of agents' metrics and skills, then the list-of-maximum-shifts may be sent to the WFM for an automatic shift-schedule generation for the activity type and a determined period, based on the list-of-maximum-shifts and other input parameters.

Furthermore, in accordance with some embodiments of the present disclosure, the automatically generated shift-schedule may be presented to a user via a display unit.

Furthermore, in accordance with some embodiments of the present disclosure, the other input parameters may be (i) forecast and staffing plans; and (ii) agent's skills and preferences.

Furthermore, in accordance with some embodiments of the present disclosure, the preconfigured number of metrics are selected from at least one of: (i) level of adherence; (ii) quality score; (iii) Average Handle Time (AHT); (iv) agent sentiment score; (v) available time; (vi) average speed of answer (vii) concurrent time; (viii) consult time; (ix) working time; (x) agent contracts; (xi) holds; (xii) refused contacts; (xiii) takeovers; (xiv) occupancy; (xv) active talk time; and (xvi) working rate.

Furthermore, in accordance with some embodiments of the present disclosure, each metric of the preconfigured number of metrics is converted into an aggregated percentage value of the metric during a preconfigured period.

Furthermore, in accordance with some embodiments of the present disclosure, a nature of each preconfigured attributed weight may be selected from (i) positive; (ii) zero; and (iii) negative. For each metric, an attributed weight may be determined as positive when a metric has a positive correlation with the APS, the attributed weight may be determined as zero when a metric is not considered for APS calculation and the attributed weight may be determined as negative when the metric has a negative correlation with APS.

Furthermore, in accordance with some embodiments of the present disclosure, the preconfigured number of metrics may be retrieved from at least one application of: (i) Automatic Call Distribution (ACD); (ii) Quality Management (QM); (iii) Workforce Management (WFM); (iv) Interaction Analytics (IA); and (v) other applications.

Furthermore, in accordance with some embodiments of the present disclosure, upon selection of a manual schedule change via a Graphical User Interface (GUI) for shift schedules update, the APSG may be operated for each agent in the data store of agent's metrics and skills which are not scheduled for the received period.

Furthermore, in accordance with some embodiments of the present disclosure, the APSG module may be further including generating a report showing trends of the agents preconfigured number of metrics against past shift-schedules.

Furthermore, in accordance with some embodiments of the present disclosure, the report may be used for agents coaching purposes.

Furthermore, in accordance with some embodiments of the present disclosure, each day in the period may include two or more shifts.

Furthermore, in accordance with some embodiments of the present disclosure, the retrieved historical-data of the preconfigured number of metrics may be converted to a percentage value for the calculated weighted sum of the retrieved historical-data of the preconfigured number of metrics.

There is further provided a computerized-system for increasing productivity of agents in a contact center by improving an automatic-scheduling generation in a Workforce Management (WFM) application.

Furthermore, in accordance with some embodiments of the present disclosure, the computerized system may include one or more processors, one or more applications, and a memory including a data store of agents' metrics and skills and a data store of applications.

Furthermore, in accordance with some embodiments of the present disclosure, the one or more processors may be configured to operate an Agent Productivity Score Generator (APSG) module, for each agent in the data store of agents' metrics and skills.

Furthermore, in accordance with some embodiments of the present disclosure, the APSG may be configured to operate as described above.

### BRIEF DESCRIPTION OF THE DRAWINGS

FIG. 1 schematically illustrates a high-level diagram of a system for increasing productivity of agents in a contact center by improving an automatic-scheduling generation in a Workforce Management (WFM) application, in accordance with some embodiments of the present disclosure;

FIGS. 2A-2B are a high-level workflow of an Agent Productivity Score Generator (APSG) module, in accordance with some embodiments of the present disclosure;

FIG. 3A illustrates an example of a Graphical User Interface (GUI) for an automatic-scheduling generation in a WFM application, in accordance with some embodiments of the present disclosure;

FIG. 3B illustrates an example of GUI for improving an automatic-scheduling generation in a WFM application by increasing productivity of agents in a contact center, in accordance with some embodiments of the present disclosure;

FIG. 4 illustrates an example of a GUI for configuring daily rules for an automatic-scheduling generation in a Workforce Management (WFM) application, in accordance with some embodiments of the present disclosure;

FIG. 5 illustrates an example of a GUI for configuring agent's availability preferences for an automatic-scheduling generation in a WFM application, in accordance with some embodiments of the present disclosure;

FIG. 6 illustrates an example of an output of an automatic-scheduling generation in a WFM application, in accordance with some embodiments of the present disclosure;

FIG. 7 illustrates an example an Agent Productivity Score (APS) for each shift in a period of agents and a change in start time of schedule based on the APS, in accordance with some embodiments of the present disclosure; and

FIG. 8 is a high-level workflow of an automatic-scheduling generation in a WFM application based on an ASP, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current systems in contact centers, Workforce Management (WFM) scheduling is driven merely by staffing plans, daily or weekly rules, and agent's static preferences. Agent's productivity can differ according to time of day, which is not considered in existing scheduling algorithms. Current solutions lack scheduling based on agents' productivity using Key performance indicators (KPI)s.

Furthermore, in current systems, ad hoc schedule changes are performed by a manager without having insights as to best suited agents for each shift, from the aspect of agents productivity, at any point of time. In a contact center having thousands of agents, in situations of unexpected spikes in demand for call center services, e.g., high call volume, when the manager would like to adapt to the situation by adding agents which are not scheduled to the shift, she may require a list of suggested additional agents to be selected for activities on existing scheduled-shifts.

The term “forecast” as used herein refers to predicting peaks and bottoms of all incoming customer demand throughout the day, week, month, or season or even minute interval and then matching up staffing requirements to effectively meet that demand.

The term “staffing plan” as used herein refers to a strategic plan that an organization uses to identify its personnel needs by skills, time of day and by day of week over a period.

The “scheduling unit” as used herein refers to organizing employees into groups with common scheduling requirements. The requirements include the operating days and hours of the unit which may have more than one working shift. For example, groups of employees working specific shifts in a specific location or employees working in a specific department.

The term “daily rule” as used herein refers to templates for possible shifts and their activities in a day. For example, a daily rule may be created for a weekday morning, which may have different activities than a night/weekend shift.

The term “weekly rule” as used herein refers to rules that group daily rules together. They define how the agent's week can be organized. Employees must be associated to a weekly rule to be assigned to a shift.

Accordingly, there is a need for a system and method for increasing productivity of agents in a contact center by improving an automatic-scheduling generation in a Workforce Management (WFM) application, by taking into account agents productivity using KPI metrics to place the agents in shifts where their productivity is the highest.

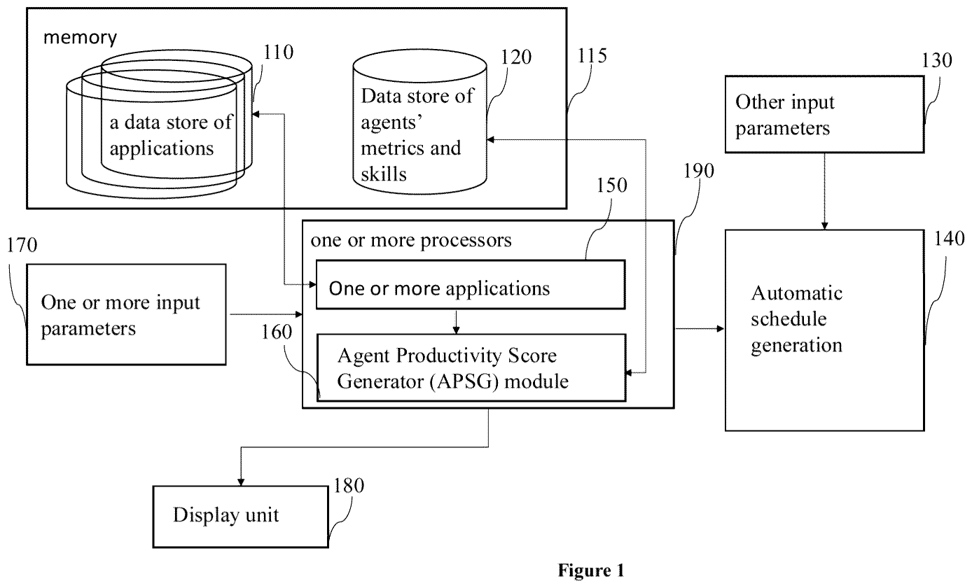

FIG. 1 schematically illustrates a high-level diagram of a system 100 for increasing productivity of agents, in a contact center, by improving an automatic-scheduling generation in a Workforce Management (WFM) application, in accordance with some embodiments of the present disclosure.

According to some embodiments of the present disclosure, the improvement of the automatic-scheduling generation, in a WFM application, may be implemented by having agents placed in shifts in which they are most productive, according to related historic data of preconfigured KPI metrics.

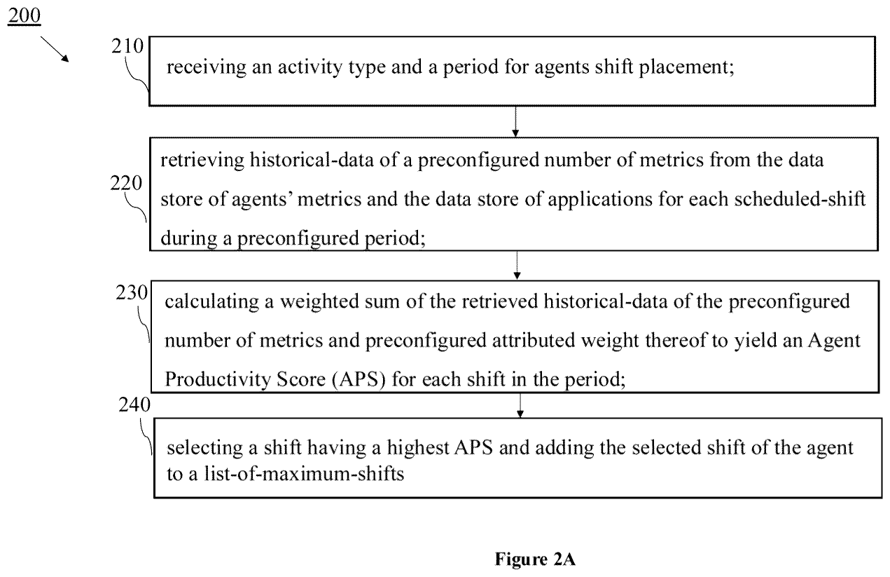

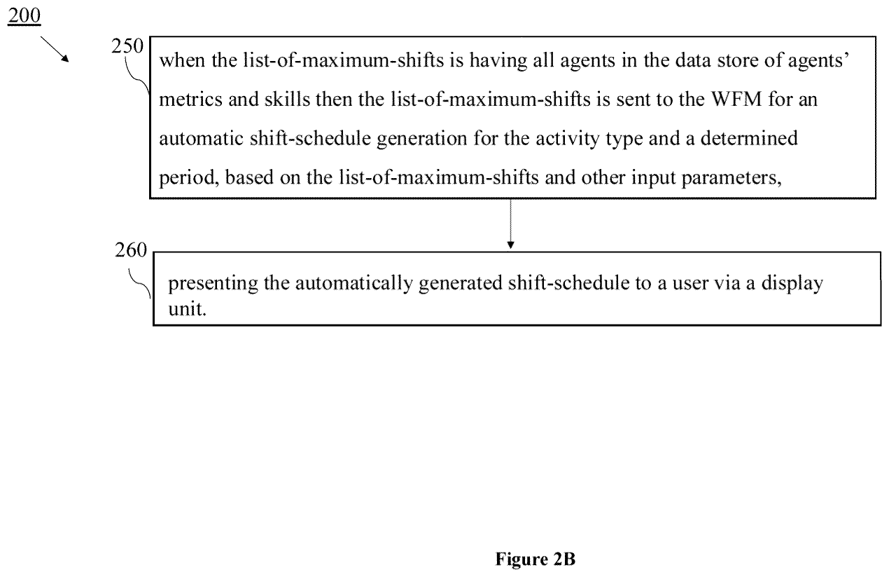

According to some embodiments of the present disclosure, in a computerized-system, such as system 100 that includes one or more processors 190, one or more applications 150, and a memory 115 including a data store of agents' metrics and skills 120 and a data store of applications 110, the one or more processors 190 may operate a module, such as Agent Productivity Score Generator (APSG) module 160, and such as APSG 200 in FIGS. 2A-2B, for each agent in the data store of agents' metrics and skills 120 to improve an automatic-scheduling generation in a WFM application by placing agents in shift in which they are most productive based on historic data of preconfigured KPI metrics and thus increasing the productivity of the agents in the contact center.

According to some embodiments of the present disclosure, the APSG module 160 may generate a list-of-maximum-shifts that may have a shift for each agent that is having a calculated highest Agent Productivity Score (APS) and then may send it to the WFM system for an automatic shift-schedule generation for an activity type and a determined period, based on the list-of-maximum-shifts and other input parameters. The determined period may be a week or a month or any other period. The other input parameters may be forecast and staffing plans; and (ii) agent's skills and preferences.

According to some embodiments of the present disclosure, the APSG module 160 may include receiving an activity type and a period for agents shift placement and then based on preconfigured number of metrics from the data store of agents' metrics 120, retrieving historical-data from the data store of applications 110 for each scheduled-shift during a preconfigured period.

According to some embodiments of the present disclosure, the preconfigured number of metrics are selected from at least one of: (i) level of adherence; (ii) quality score; (iii) Average Handle Time (AHT); (iv) agent sentiment score; (v) available time; (vi) average speed of answer (vii) concurrent time; (viii) consult time; (ix) working time; (x) agent contracts; (xi) holds; (xii) refused contacts; (xiii) takeovers; (xiv) occupancy; (xv) active talk time; and (xvi) working rate.

According to some embodiments of the present disclosure, since the KPI metrics may be aggregated from different applications or domains, its unit may differ. For example, some metrics like adherence and working rate may be stored in percentage value, while other metrics may be time based or numeric KPIs. Therefore, all the metrics have to be aggregated to a percentage value, to be used in the weighted mean formula to calculate the APS. That is, each metric of the preconfigured number of metrics may be converted into an aggregated percentage value of the metric during a preconfigured period.

According to some embodiments of the present disclosure, in a non-limiting example, for an agent on a shift from 10 AM till 12 PM on Monday in activity type ‘open’ and a skill such as ‘voice’, the metric agent sentiment may be converted into an aggregated percentage value by the following formula:

Average percentage value of a metric=number of interactions in a shift for the metric/number of total interactions in the shift with a skill for the metric.

According to some embodiments of the present disclosure, for example, when the metric may not be aggregated to a percentage value it may be calculated based on occurrences. For example, the AHT metric, may be calculated by mapping a range of number of occurrences to a percentage value. For example, by the following formula:

Occurrence percentage value of a metric=number of interactions in a shift for the metric with value g/number of total interactions in the shift with a skill for the metric. In case of AHT metric the group may be time such that a value less than 1 minute, between 1-2 minutes and so on.

According to some embodiments of the present disclosure, when the skill value may not be specified in the input parameters, it may not be used in percentage value computation leading to generalized productivity score.

According to some embodiments of the present disclosure, the APSG module 160 may further include calculating a weighted sum of the retrieved historical-data of the preconfigured number of metrics and preconfigured attributed weight thereof to yield an Agent Productivity Score (APS) for each shift in the period for each agent.

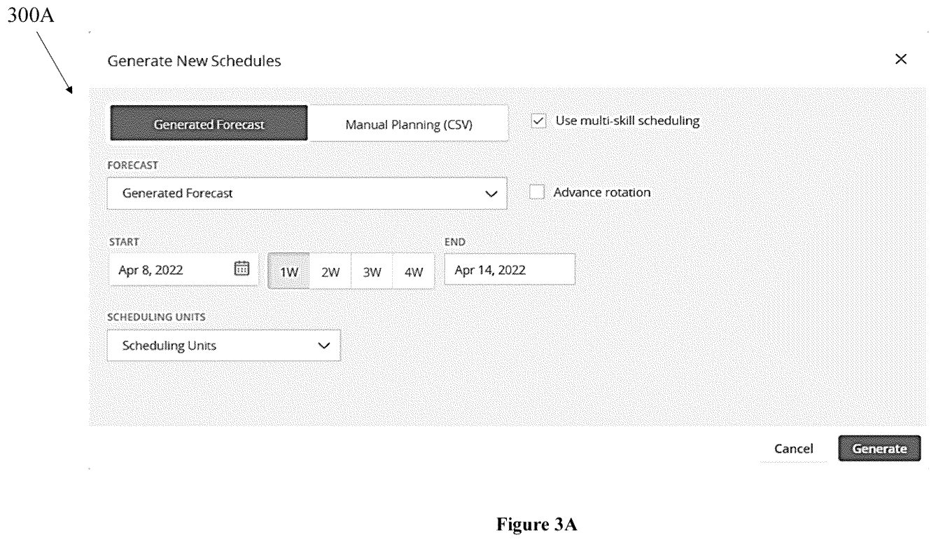

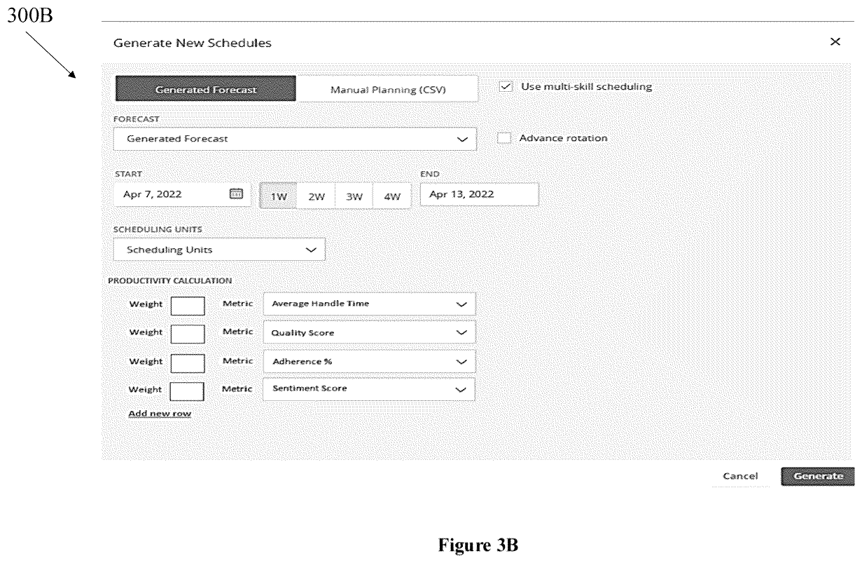

According to some embodiments of the present disclosure, a nature of each preconfigured attributed weight may be selected from (i) positive; (ii) zero; and (iii) negative. For each metric, an attributed weight may be determined as positive when a metric has a positive correlation with the APS, the attributed weight may be determined as zero when a metric is not considered for APS calculation and the attributed weight may be determined as negative when the metric has a negative correlation with APS, as shown in GUI 300B in FIG. 3B. The weight may be ranging between ‘0’ to ‘1’. And the total sum of the weights is ‘1’.

According to some embodiments of the present disclosure, for example, when a business scenario when a high call volume is being forecasted, then to generate the schedule in this situation, a metric, such as ‘Average Handle Time’ may be attributed a higher weight value than the other metrics, via a GUI, such as GUI 300B, in FIG. 3B.

According to some embodiments of the present disclosure, the preconfigured number of metrics may be retrieved from at least one application of: (i) Automatic Call Distribution (ACD); (ii) Quality Management (QM); (iii) Workforce Management (WFM); (iv) Interaction Analytics (IA); and (v) other applications.

According to some embodiments of the present disclosure, the ASP may be calculated based on the formula:

ASP=W1×M1+W2×M2+ . . . +W(n)*M(n)

whereby:
W(i) is a weight for the i^{th} metric ranging between 0 to 1 such that ωWi=1, and
M(i) is a percentage value of the metric.

According to some embodiments of the present disclosure, for example, the APS may be calculated as follows:

ASP=W₁×M₁+W₂×M₂+W₄×M₄−W₃×M₃

whereby:
M₁ is a metric, such as Average Handle Time (AHT), which may be retrieved from an ACD system, and attributed a positive weight of W₁,
M₂ is a metric, such as quality scores, which may be retrieved from a Quality Management (QM) system, and attributed a positive weight of W₂,
M₃ is a metric, such as adherence, which may be retrieved from a WFM system, and attributed a negative weight of W₃, and
M₄ is a metric such as agent sentiment score, which may be retrieved from an interaction analytics system, and attributed a positive weight of W₄.

According to some embodiments of the present disclosure, the APSG module 160 may further include selecting a shift having a highest APS and adding the selected shift of the agent to a list-of-maximum-shifts. When the list-of-maximum-shifts is having all agents in the data store of agents’ metrics and skills, then the list-of-maximum-shifts may be sent to the WFM system for an automatic shift-schedule generation 140 for the activity type and a determined period, based on the list-of-maximum-shifts and other input parameters 130. Each day in the determined period includes two or more shifts.

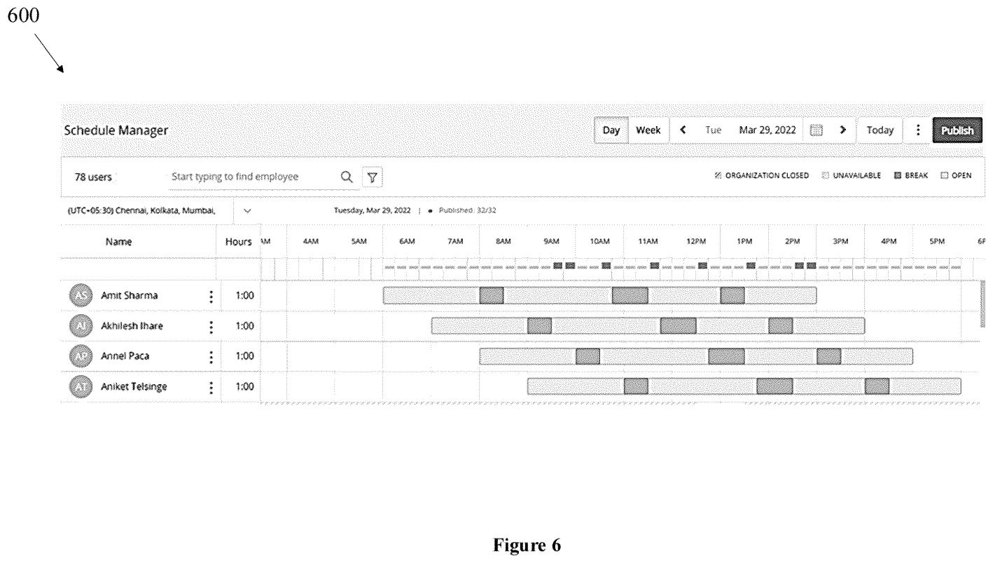

According to some embodiments of the present disclosure, the automatically generated shift-schedule may be presented to a user via a display unit 180, for example, as shown by GUI 600 in FIG. 6.

The generated automatic shift-schedule may be driven by agent's productivity score along with the agent's preferences.

According to some embodiments of the present disclosure, upon selection of a manual schedule change via a Graphical User Interface (GUI) for shift schedules update, the APSG 160 may be operated for each agent in the data store of agent's metrics and skills which are not scheduled for the received period.

According to some embodiments of the present disclosure, the APSG module 160 may further include generating a report showing trends of the agents preconfigured number of metrics against past shift-schedules. The report may be used for agents coaching purposes. Some of the metrics on the report may be APS distribution over time of day, each KPIs trend over time. These metrics may be in the form of a graph for each agent or aggregated for multiple agents.

According to some embodiments of the present disclosure, the APS may be per agent, e.g., general productivity score or the APS may be per agent per skill, e.g., skills-based productivity score. The nature of the APS may be determined by the selected KPI metrics, e.g., as shown in FIG. 3B.

FIGS. 2A-2B are a high-level workflow of an Agent Productivity Score Generator (APSG) module 200, in accordance with some embodiments of the present disclosure;

According to some embodiments of the present disclosure, operation 210 may comprise for each agent in in the data store of agents' metrics and skills receiving an activity type and a period for agents shift placement. For example, the activity type may be ‘open’, ‘on call’, ‘break’, ‘meeting’, ‘lunch’, ‘out of office’, ‘planned leaves’ etc.

According to some embodiments of the present disclosure, operation 220 may comprise retrieving historical-data of a preconfigured number of metrics from the data store of agents' metrics and the data store of applications for each scheduled-shift during a preconfigured period. For example, the metrics may be Average Handle Time (AHT), quality score, adherence and sentiment score as shown, for example, in GUI 300B, in FIG. 3B.

According to some embodiments of the present disclosure, operation 230 may comprise calculating a weighted sum of the retrieved historical-data of the preconfigured number of metrics and preconfigured attributed weight thereof to yield an Agent Productivity Score (APS) for each shift in the period. The APS may be yielded for each shift in the period for each agent.

According to some embodiments of the present disclosure, operation 240 may comprise selecting a shift having a highest APS and adding the selected shift of the agent to a list-of-maximum-shifts.

According to some embodiments of the present disclosure, operation 250 may comprise when the list-of-maximum-shifts is having all agents in the data store of agents' metrics and skills then the list-of-maximum-shifts is sent to the WFM for an automatic shift-schedule generation for the activity type and a determined period, based on the list-of-maximum-shifts and other input parameters.

According to some embodiments of the present disclosure, operation 260 may comprise presenting the automatically generated shift-schedule to a user via a display unit.

FIG. 3A illustrates an example of a Graphical User Interface (GUI) 300A for an automatic-scheduling generation in a WFM application, in accordance with some embodiments of the present disclosure.

According to some embodiments of the present disclosure, in current systems a GUI, such as GUI 300A, may be used for generating new schedules for a determined period, such as a week having a start date and end date. Schedule generation for an agent refers to determining which activity will be performed by the agent at a particular time of day. Various automated schedule generation algorithms are available, which are currently driven only by static parameters.

The GUI 300A may be a GUI for a manager to specific generation, which is associated to an automatic scheduling engine to generate schedules based on input static parameters. A schedule manager microservice may be used to store and display the generated schedules on a user interface.

The static parameters may be for example, list of agents to be scheduled, set of skills associated with each agent, list of activities to be used for scheduling daily rules associated with the schedule of the agent, weekly rules which are weekly limits associated with the agent's schedule and forecast result which are forecasted staffing results based on the historical data.

These parameters are referred to as static because they need to be configured in the system only one time and they do not change based on agent's performance results or actual activity performed by the agent and have to be configured in the system before the schedules generation. Moreover, every agent has an automated way to request changes to the schedule and the manager has to make an adjustment to the schedules manually. To do the same, the manager has to be aware of available agents and their performance. However, in current systems do not provide a recommendation as to the best suitable agent for a requested change from the aspect of productivity of the agent, based on historic data of one or more KPI metrics.

To generate schedules the admin or manager has to select parameters like scheduling units, e.g., grouping of agents, automated staffing or manual import staffing, and the date range for which schedule may be generated. These selected parameters are being passed to an automatic schedule generation system and it generates schedules by performing scheduling algorithms on received input parameters.

FIG. 3B illustrates an example of GUI 300B for improving an automatic-scheduling generation in a WFM application by increasing productivity of agents in a contact center, in accordance with some embodiments of the present disclosure.

According to some embodiments of the present disclosure, GUI 300B may be used for automatic-scheduling generation in a WFM application, with a preconfigured number of metrics that may be retrieved from data stores, such as the data store of agents' metrics and the data store of applications for each scheduled-shift during a determined period. For example, the determined period may be a week starting on Apr. 7, 2022, and ending on Apr. 13, 2022.

According to some embodiments of the present disclosure, a user may configure the metrics along with their weight.

According to some embodiments of the present disclosure, for each metric, the attributed weight may be determined as positive when a metric has a positive correlation with the Agent Productivity Score Generator (APS), the attributed weight may be determined as zero when a metric is not considered for APS calculation and the attributed weight may be determined as negative when the metric has a negative correlation with APS.

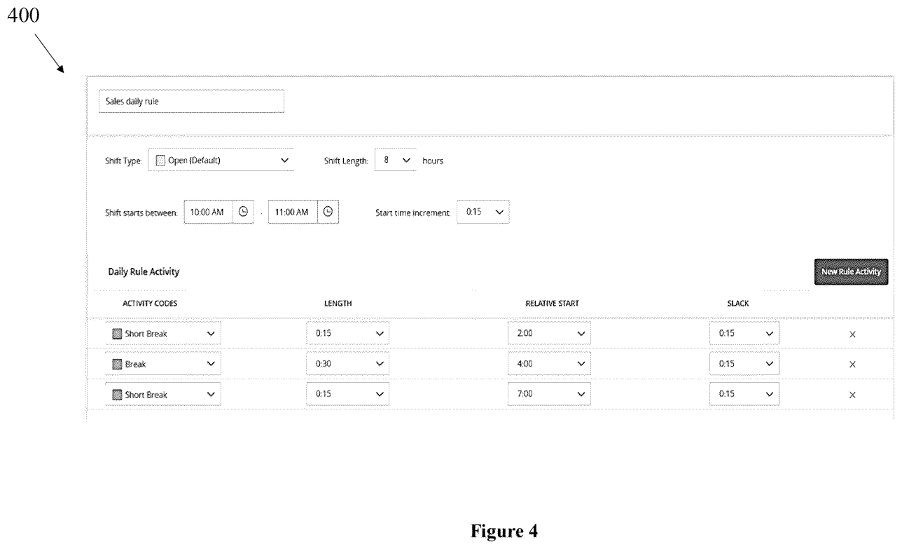

FIG. 4 illustrates an example of a GUI 400 for configuring daily rules for an automatic-scheduling generation in a WFM application, in accordance with some embodiments of the present disclosure.

According to some embodiments of the present disclosure, via GUI 400 a manager may specify the input for the automatic scheduling algorithm.

According to some embodiments of the present disclosure, some of the parameters like scheduling units, date range and forecast or staffing plan may be configured in GUI 400.

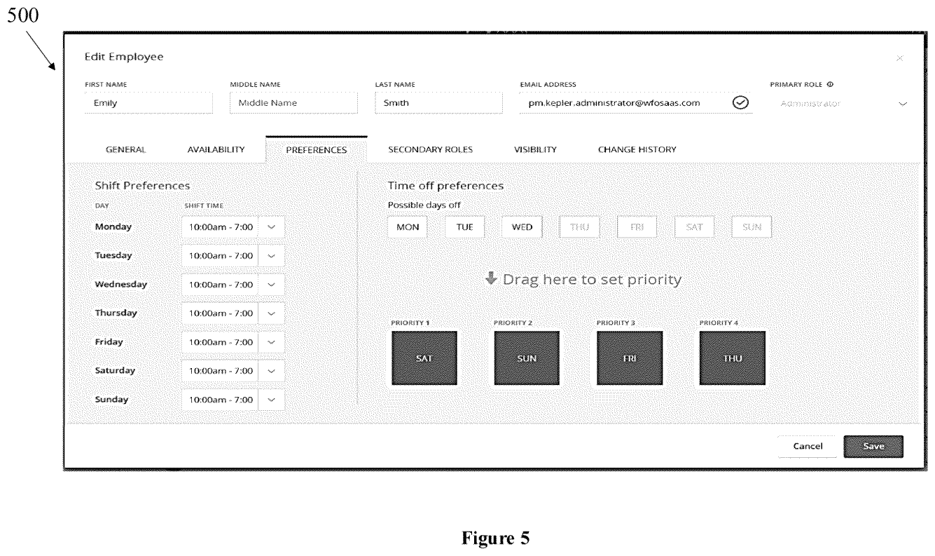

According to some embodiments of the present disclosure, other configurations like agent preference and daily rules may be specified separately, as shown in GUI 500 in FIG. 5.

FIG. 6 illustrates an example 600 of an output of an automatic-scheduling generation in a WFM application, in accordance with some embodiments of the present disclosure.

According to some embodiments of the present disclosure, a module, such as Agent Productivity Score Generator (APSG) module 160 in FIG. 1, may yield an Agent Productivity Score (APS) for each shift in the period. The APSG module 160 consists of two parts. First part may be used to fetch historic data from one or more applications and the second part may be used to yield an APS for each shift for each agent.

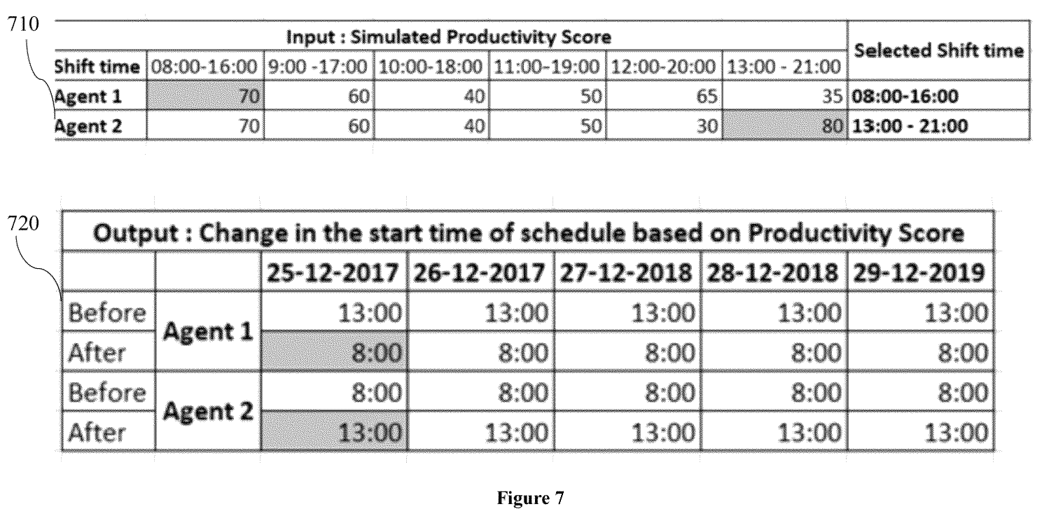

FIG. 7 illustrates an example an Agent Productivity Score (APS) for each shift in a period of agents and a change in start time of schedule based on the APS, in accordance with some embodiments of the present disclosure.

According to some embodiments of the present disclosure, table 710 is an example of yielded Agent Productivity Score (APS) for each shift in the period for agent1 and agent2. Shift time 08:00-16:00 has been calculated the highest APS for agent1 and shift 13:00-21:00 has been calculated the highest APS for agent2. Accordingly, agent1 may be scheduled for shifts time 08:00-16:00 instead of shifts time 13:00-21:00 and agent2 may be scheduled for shifts time 13:00-21 instead of shifts time 08:00-16:00, as shown in table 720.

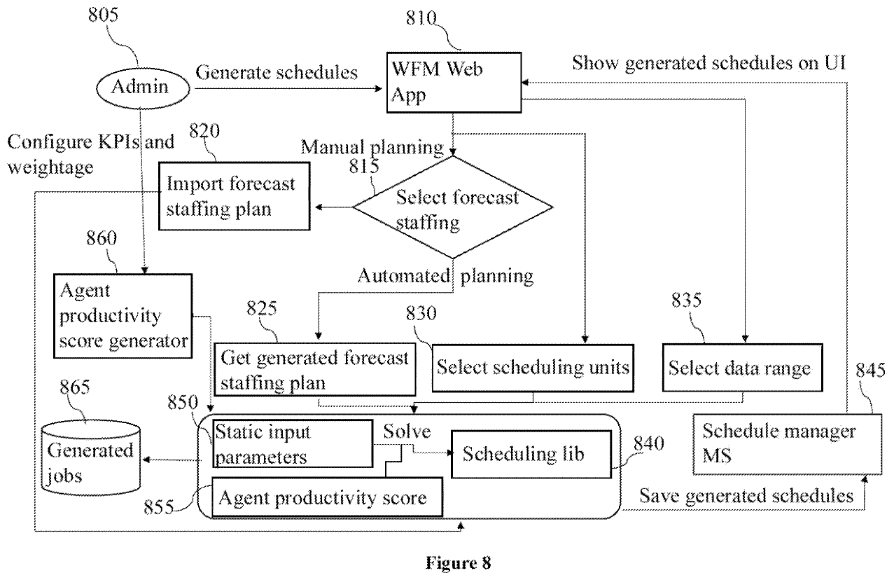

FIG. 8 is a high-level workflow of an automatic-scheduling generation in a WFM application based on an ASP, in accordance with some embodiments of the present disclosure.

According to some embodiments of the present disclosure, a user, such as an administrator 805 may select parameters e.g., via WFM web app 810 like scheduling units 830, staffing, and the date range 835 for which a schedule may be generated.

According to some embodiments of the present disclosure, upon manual schedule change via a Graphical User Interface (GUI) for shift schedules update, the APSG may be operated for each agent in the data store of agent's metrics and skills which are not scheduled for the received period.

According to some embodiments of the present disclosure, to select forecast staffing 815 then, for manual planning import forecast staffing plan 820 and for automated planning, get generated forecast staffing plan 825.

According to some embodiments of the present disclosure, the staffing plan and the selected scheduling units 830 and the selected date range 835 may be received to a module, such as Agent Productivity Score generator 860 and such as Agent Productivity Score Generator (APSG) module 160 in FIG. 1 to yield an APS for each shift for each agent. Then, selecting a shift having a highest APS and adding the selected shift of each agent to a list-of-maximum-shifts 855. When the list-of-maximum-shifts is having all agents in the data store of agents' metrics and skills then the list-of-maximum-shifts may be sent to a scheduling lib 840 of the WFM system for an automatic shift-schedule generation for the activity type and a preconfigured period, based on the list-of-maximum-shifts and static input parameters 850.

According to some embodiments of the present disclosure, the generated schedules may be saved in a data store, such as generated jobs data store 865.

According to some embodiments of the present disclosure, a schedule manager Microservice (MS) 845 may show the generated schedules via a User Interface (UI) which may be associated to the WFM web app 810.

According to some embodiments of the present disclosure, optionally, a selection of a shift having a maximum score may be operated by considering the other input parameters, e.g., forecast and staffing plans; and agent's skills and preferences, before adding a shift to the list-of-maximum-shifts. Each input parameter may have a specified calculator used to score the shift. The score of each parameter calculator, e.g., (i) staffing calculator; (ii) agent preference calculator; and (iii) Agent Productivity Score calculator, may by summed to a total score. When the total score of a shift is the highest, the shift may be added to the list-of-maximum-shifts. For example, for each shift a calculated score using staffing calculator, a calculated score using agent preference calculator and a calculated score using agent productivity score calculator may be summed to a total score, and a shift having the highest total score may be added to the list-of-maximum-shifts.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for increasing productivity of agents in a contact center by improving an automatic-scheduling generation in a Workforce Management (WFM) application, said computerized-method comprising:
in a computerized-system comprising one or more processors, one or more applications, and a memory including a data store of agents' metrics and skills and a data store of applications, said one or more processors are operating an Agent Productivity Score Generator (APSG) module, for each agent in the data store of agents' metrics and skills, said APSG module comprising:
(i) receiving an activity type and a period for agents shift placement;
(ii) retrieving historical-data of a preconfigured number of metrics from the data store of agents' metrics and the data store of applications for each scheduled-shift during a preconfigured period;
(iii) calculating a weighted sum of the retrieved historical-data of the preconfigured number of metrics and preconfigured attributed weight thereof to yield an Agent Productivity Score (APS) for each scheduled-shift in the preconfigured period; and
(iv) selecting a shift having a highest APS and adding the selected shift of the agent to a list-of-maximum-shifts,
wherein when the list-of-maximum-shifts is having all agents in the data store of agents' metrics and skills then the list-of-maximum-shifts is sent to the WFM for an automatic shift-schedule generation for the activity type and a determined period, based on the list-of-maximum-shifts and other input parameters, and
wherein the automatically generated shift-schedule is presented to a user via a display unit.

2. The computerized-method of claim 1, wherein the other input parameters are (i) forecast and staffing plans; and (ii) agent's skills and preferences.

3. The computerized-method of claim 1, wherein the preconfigured number of metrics are selected from at least one of: (i) level of adherence; (ii) quality score; (iii) Average Handle Time (AHT); (iv) agent sentiment score; (v) available time; (vi) average speed of answer (vii) concurrent time; (viii) consult time; (ix) working time; (x) agent contracts; (xi) holds; (xii) refused contacts; (xiii) takeovers; (xiv) occupancy; (xv) active talk time; and (xvi) working rate.

4. The computerized-method of claim 3, wherein each metric of the preconfigured number of metrics is converted into an aggregated percentage value of the metric during a preconfigured period.

5. The computerized-method of claim 1, wherein a nature of each preconfigured attributed weight is selected from (i) positive; (ii) zero; and (iii) negative,
wherein for each metric, an attributed weight is determined as positive when a metric has a positive correlation with the APS, the attributed weight is determined as zero when a metric is not considered for APS calculation and the attributed weight is determined as negative when the metric has a negative correlation with APS.

6. The computerized-method of claim 3, wherein the preconfigured number of metrics are retrieved from at least one application of: (i) Automatic Call Distribution (ACD); (ii) Quality Management (QM); (iii) Workforce Management (WFM); (iv) Interaction Analytics (IA); and (v) other applications.

7. The computerized-method of claim 1, wherein upon selection of a manual schedule change via a Graphical User Interface (GUI) for shift schedules update, the APSG is operated for each agent in the data store of agent's metrics and skills which are not scheduled for the received period.

8. The computerized-method of claim 1, wherein the APSG module is further comprising generating a report showing trends of the agents preconfigured number of metrics against past shift-schedules.

9. The computerized-method of claim 8, wherein the report is used for agents coaching purposes.

10. The computerized-method of claim 1, wherein each day in the period includes two or more shifts.

11. The computerized-method of claim 1, wherein the retrieved historical-data of the preconfigured number of metrics are converted to a percentage value for the calculated weighted sum of the retrieved historical-data of the preconfigured number of metrics.

12. A computerized-system for increasing productivity of agents in a contact center by improving an automatic-scheduling generation in a Workforce Management (WFM) application, said computerized-system comprising:
one or more processors,
one or more applications, and a memory including a data store of agents' metrics and skills and a data store of applications,
said one or more processors are configured to operate an Agent Productivity Score Generator (APSG) module, for each agent in the data store of agents' metrics and skills,
said APSG module is configured to:
(i) receive an activity type and a period for agents shift placement;
(ii) retrieve historical-data of a preconfigured number of metrics from the data store of agents' metrics and skills and the data stores of applications or each scheduled-shift during a preconfigured period;
(iii) calculate a weighted sum of the retrieved historical-data of the preconfigured number of metrics and preconfigured attributed weight thereof to yield an Agent Productivity Score (APS) for each shift in the preconfigured period;
(iv) select a shift having a highest APS and adding the selected shift of the agent to a list-of-maximum-shifts,
wherein when the list-of-maximum-shifts is having all agents in the data store of agents' metrics and skills the list-of-maximum-shifts is sent to the WFM for an automatic shift-schedule generation for the activity type for a determined period, based on the list-of-maximum-shifts and other input parameters, and
wherein the automatically generated shift-schedule is presented to a user via a display unit.
